(19) United States
(12) Patent Application Publication
(10) Pub. No.: US 2015/0230410 A1
(43) Pub. Date: Aug. 20, 2015

(54) Enhanced Growth Planter

(71) Applicant: Pamela Crawford, S. Palm Beach, FL (US)

(72) Inventor: Pamela Crawford, S. Palm Beach, FL (US)

(21) Appl. No.: 14/180,554

(22) Filed: Feb. 14, 2014

(51) Int. Cl. A01G 9/02

(52) U.S. Cl. CPC A01G 9/02

(57) ABSTRACT

This invention relates to the design and construction of a novel planter to enhance plant growth.

### FIELD OF THE INVENTION

This invention relates to the design and construction of a novel planter to enhance plant growth.

### BACKGROUND OF THE INVENTION

Container gardening is an increasingly popular gardening technique and containers and liners used to plant plants in the top of the containers are well known in the prior art. Traditionally, a gardener will use a wire form container lined with a rigid liner designed specifically to only allow plants to be planted in the top of the container with the liner left visible through the sides of the container.

A major disadvantage attributable to the design and construction of prior art planters is that the prior art planters only allow the plants to be planted in the top of the containers. In the event a planter is only top planted, it typically will take months before the top-planted plants will grow long enough to cover the sides of the planter.

The prior art planters also are not designed to accommodate side-planted plants because the spacing of the wires are not sized to allow the passage of the root balls of the commonly-sold garden center plants though the sides of the containers and are not spaced correctly to prevent over planting, which causes plants to die quickly. Additionally, most traditional planter are not designed to allow the root balls to be inserted through the sides of the liners. Most liners are formed of solid materials and are designed to prevent the plants and soil from falling trough the wire forms.

In view of the prior arts' shortcomings, it is thus desirable to create a method of side-planting plants in planters so that the planters will efficiently provide for full growth of all planted material. Moreover, there is clearly a need for a planter product that will provide a means for efficiently accomplishing the side-planting method, as the prior art planters are not designed to accommodate side planting.

### SUMMARY OF THE INVENTION

The inventive structure presents a number of advantages over the prior art.

It is designed specifically for the method of side planting, and the planter acts as a guide to prevent users from over planting, which causes the plants to die, and positions plants for maximum efficient growth. This feature is particularly useful because most gardeners are novices and while they would enjoy having a container garden, it can be very difficult to plant and maintain a container garden without a lot of experience. The angle of the sidewalls in certain embodiments as claimed also increase sunlight exposure over the prior art and create a planter container which more efficiently stores and distributes growth medium and water to the root systems. The present invention will provide a simple and effective guide for novice container gardens thus decreasing the chance of error.

### BRIEF DESCRIPTION OF THE DRAWINGS

FIG. 1 is a depiction of a prior art top-planted container and liner.

FIG. 2 is a view of a single-layer planter according to the embodiments described herein.

### DETAILED DESCRIPTION OF THE INVENTION

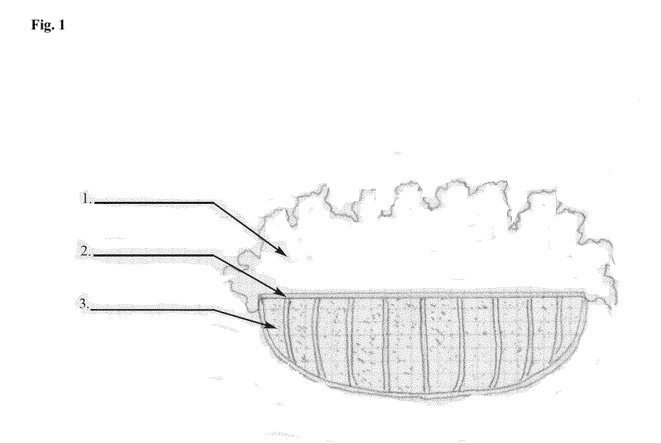

Shown in FIG. 1 is a depiction of a prior art top-planted planter. The plants (1) are planted in the top of the wire form container (2), which is lined with a solid liner (3) that is designed to prevent the plants (1) and soil from falling through the spaces between the wires of the wire form container (2).

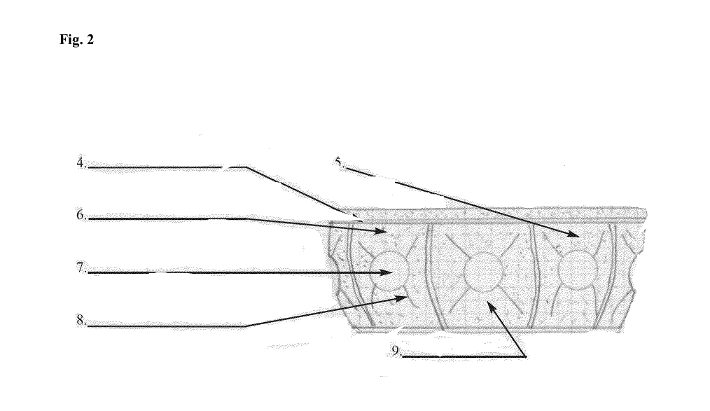

Shown in FIG. 2 is a drawing of the present invention. The planter (4) is formed of openings (5) spaced to allow the passage of one root ball through the side of the container (4) and a liner (6). In the preferred embodiment, the openings (5) are spaced about 3.5″×3.5″ from center to center and the vertical angle of the container sides may vary from about 60 degrees to 135 degrees to ensure that the bottom plants receive enough light to grow.

What is claimed:

1. A planter consisting of:
a container with a plurality of openings on the sides of the container wherein the container has a side wall at an angle not less than 60 degrees and not more than 135 degrees from the vertical; and
a separate liner with a plurality of pre-cut holes sized to accept and retain the root ball of a plant.

2. A planter as described in claim 1 wherein the container openings are spaced no less than 3.5″×3.5″ from the center of one to the center of another.
